(19) United States
(12) Patent Application Publication
(10) Pub. No.: US 2012/0105466 A1
(43) Pub. Date: May 3, 2012

(54) Communication to an Audience at an Event

(76) Inventor: Kemal Leslie, Winnipeg (CA)

(21) Appl. No.: 13/205,742

(22) Filed: Aug. 9, 2011

Related U.S. Application Data
(60) Provisional application No. 61/409,318, filed on Nov. 2, 2010.

(51) Int. Cl. G09G 5/02; G09G 5/00

(52) U.S. Cl. 345/589; 345/634

(57) ABSTRACT

A device application software and server data interchange control mechanism provides synchronized screen displays on hand held communication devices at an event in an auditorium where each screen acts as a single pixel in a macro display to be controlled by the central control system and visible to the audience as a whole. The macro display can provide flashes, waves, graphics, and animation. The devices can be multi platform and/or single platform smart-phones as well as any other palmtop computers or mobile devices that function as an interactive data and media device, personal information manager, and/or PDA.

This application claims the benefit under 35 USC 119 of Provisional Application 61/409318 filed Nov. 2, 2010.

This invention relates to a method and system for communication to an audience at an event.

### BACKGROUND OF THE INVENTION

Many events containing an audience are carried out in cities all over the world where the presence of the audience and the cooperation of the audience in the event is a significant part of the experience both for the performers and for the audience. To this end many techniques have been used to contribute to the communication including lighting, pyrotechnics, sound effects, video screens and many others.

### SUMMARY OF THE INVENTION

It is one object of the present invention to provide a method and system which allows further enhancement of the communication between audience and participants which can contribute to the experience.

According to one aspect of the invention there is provided an apparatus for communication to an audience at an event comprising:

an arrangement for collecting information from a plurality of audience members at the event relating to their presence and their respective location at the event;

an arrangement for communication through one or more networks with hand held communication devices of the plurality of audience members, each hand held communication device having a display screen which can display a color on the screen;

a computer control system for generating a moving macro image to be displayed to the audience at the event, the moving macro image being made up of individual color pixels where each pixel is defined by one of or a plurality of the hand held communication devices at the respective locations;

the computer control system being arranged to communicate data to the hand held communication devices of the audience members;

the computer control system being arranged such that the data provides instructions to the hand held communication devices so that when the display screens of the hand held communication devices are displayed in the event by the audience members the display screens cooperate to provide a combined visual effect to the audience defined by the moving macro image.

Preferably the arrangement for collecting information from a plurality of audience members at the event relating to their respective location is arranged such that the information is obtained at the time of the audience member entering the location.

Preferably the arrangement for collecting information from a plurality of audience members at the event relating to their respective location is arranged such that the information is obtained by seat identification.

Preferably the information is communicated to the hand held communication devices. For example, the information can be communicated by a mobile device camera for reading a bar code to identify user seat location.

Alternatively the information is communicated to the computer control system independently of the hand held communication devices such as through an internet connection or other network connection. For example the information can be communicated by a data interchange process in connection with the ticket seller to automate the input of the user's location to the mobile device, and/or the command control database.

As a further alternative the arrangement for collecting information from a plurality of audience members at the event relating to their respective location can be arranged such that the information is obtained by identifying the coordinates of the hand held communication device.

In most cases the data is arranged to cause the display screen to display a single solid color patch covering the whole screen. This does not of course preclude the fact that other information can be communicated to the end user by the computer system as a separate matter, such as advertising information or event information.

Typically, where the system is intended for use on conventional mobile devices of the users, the system can include a downloadable app to be downloaded to each of the hand held communication devices of the audience members when requested. However this does not preclude that the system is used with mobile devices dedicated to this system and not intended to be used by the user at other times. Thus at certain events the system can use some existing mobile phones which are then supplemented by dedicated devices handed out to other participants.

In most cases the system is concerned only with the visual display which requires each mobile device only to display a single color patch. In this case there is no multi-media communication to the mobile devices, simply a single medium of a single color patch. However the system can also be used where the data communicated to the hand held communication devices also provides audio coordination of the devices.

In order to carry out the system within an allowable bandwidth, the computer control system is preferably arranged to transmit a plurality of common screen control command strings which include individual ID addresses for selection by the hand held communication devices.

In order to carry out the system within an allowable bandwidth, the computer control system is preferably arranged to transmit only data which provides for a selected hand held communication device a color instruction for display as a solid color patch on the screen and timing information as to when the color patch should be displayed. That is the data transmitted is reduced in complexity to simple components of color and timing which can be carried out within the allowable band width.

In some cases the computer control system can be arranged to transmit an instruction to generate a sound or vibration on the hand held communication device to notify the user of a pending graphical display event or a countdown to a display event.

In some cases the computer control system can be arranged to transmit an instruction to generate a screen countdown for users to hold up devices at the correct time.

In some cases the system can include a peripheral device for use with the mobile device to enhance the display effect created by the display of the hand held communication device such as a display magnifier, which enhances what is displaying on the user mobile device.

According to a second aspect of the invention there is provided an apparatus for communication to an audience at an event comprising:

an arrangement for collecting information from a plurality of audience members at the event relating to their presence and their respective location at the event;

an arrangement for communication through one or more networks with hand held communication devices of the plurality of audience members, each hand held communication device having a display screen which can display a color on the screen;

a computer control system for generating an image to be displayed to the audience at the event, the image being made up of individual color pixels where each pixel is defined by one of or a plurality of the hand held communication devices at the respective locations;

the computer control system being arranged to communicate data to the hand held communication devices of the audience members;

the computer control system being arranged such that the data provides instructions to the hand held communication devices so that when the display screens of the hand held communication devices are displayed in the event by the audience members the display screens cooperate to provide a combined visual effect to the audience defined by the image;

wherein the computer control system is arranged to transmit the data by a plurality of common screen control command strings which include individual ID addresses for selection by the hand held communication devices.

According to a third aspect of the invention there is provided an apparatus for communication to an audience at an event comprising:

an arrangement for collecting information from a plurality of audience members at the event relating to their presence and their respective location at the event;

an arrangement for communication through one or more networks with hand held communication devices of the plurality of audience members, each hand held communication device having a display screen which can display a color on the screen;

a computer control system for generating an image to be displayed to the audience at the event, the image being made up of individual color pixels where each pixel is defined by one of or a plurality of the hand held communication devices at the respective locations;

the computer control system being arranged to communicate data to the hand held communication devices of the audience members;

the computer control system being arranged such that the data provides instructions to the hand held communication devices so that when the display screens of the hand held communication devices are displayed in the event by the audience members the display screens cooperate to provide a combined visual effect to the audience defined by the image;

wherein the computer control system is arranged to transmit to the hand held communication devices for the image to be displayed at the venue data which provides for a selected hand held communication device a color instruction for display as a solid color patch on the screen and timing information as to when the color patch should be displayed.

The arrangement described herein therefore provides a device application software and server data interchange control mechanism providing synchronized screen displays and/or audio outputs on hand held communication device at an event, such as multi platform and/or single platform smart-phones as well as any other palmtop computers, tablets, or mobile devices that function as an interactive data and media device, personal information manager, and/or PDA.

Also included in the system is an arrangement by which the system obtains and uses as part of the communications the seat, row, section, and venue information (as geographic location identifier) within event of user device for purpose of synchronizing displays to form one image, effect, or animated sequence.

The system also serves as a membership data driver that will obtain information such as customer email, interests, media preferences and other data useful for sophisticated marketing, service provision, and social networking. The membership that is created through this medium will also provide the user an account on the system's online Internet web site. The website will provide a series of sports and entertainment related services and user profiles including but not limited to a tour passport page, showing the various events attended by the user, their artists/sports teams of choice, and blogging features for example. Various merchandise will also be available for sale both via the mobile app and web site.

The system uses wi-fi and/or cellular data transfer technology and incorporates any or all data transfer speed technologies such as 1x, 3g, 4g, LTE and higher level data interchange methodologies as they become available.

The present application reserves right on satellite transmission and receiving technology for purpose of use as defined.

Data can be transmitted to the hand held communication devices via SMS instant message, e-mail, data streaming, Internet, intranet, and/or downloads. Push out notifications may or may not be communicated prior to data push when application is active. If the App is not active, a notification will be communicated to the user mobile device and request authorization to accept data.

System can use uploading capabilities using the signal types and data interchange technologies as noted above.

The application also can include interactive games, contests, and/or live blogging features, video capture tools for user participation in video playback on large screen devices to be controlled by event proprietor.

The application also can include event information tool features (ex. Artist info, trivia, etc).

Data can come pre-loaded on user applications prior to the event or be downloaded at the event.

A Data Control Center also forms a central part of the System which will use both:

1. Proprietary presentation development on behalf of promoter or event organizer/entity for specific events on or before event date, and/or

2. Third party user Administration Interface(s) for development of presentations designed for specific events, tours, or entities with rights granted to them through various licenses which may be in return for consideration. Multiple user IDs will also be made available for purpose of multiple presentation development administrators or approved parties (ex. Event Sponsors etc.)

Revenues can be derived from any one, combination, or, all of the following:

Advertisements on mobile device screen directed at the independent user through use of various features of the application;

Ad media (displays through macro effect on multiple synchronized user screens);

Promoter media development revenue;

License fees obtained from promoter, sponsor, and/or any other form of customer environment as deemed appropriate;

Sale of merchandise, media, and other products either live, before, or after event;

an activation fee for each event charged either to the mobile user, or the event or entertainment licensee (that is a concert artist, sports team, etc).

The plurality of mobile device screens thus project a synchronized two or three dimensional motion by individual screen color control to achieve the macro optical effect of moving image(s) or animated effect(s). The purpose of this allows for the human brain to fuse together the combination of mobile displays and macro display motion to perceive what is being displayed.

The system uses screen control command strings transmitted by data packet to the devices requiring minimal memory storage, server time, and network bandwidth.

The system can also use audio control command strings transmitted by data packet to the devices requiring minimal memory storage, server time, and network bandwidth.

### BRIEF DESCRIPTION OF THE DRAWINGS

One embodiment of the invention will now be described in conjunction with the accompanying drawings in which:

FIG. 1 is an illustration of the data assembly method of the graphical design interface at a sample venue.

FIG. 2 is a schematic representation of an exemplary device data exchange methodology between the base system(s) and the mobile devices.

FIG. 3 is a schematic representation of an exemplary data mobile screen control method using an exemplary command data structure to provide the string of commands shown hereinafter.

In the drawings like characters of reference indicate corresponding parts in the different figures.

### DETAILED DESCRIPTION

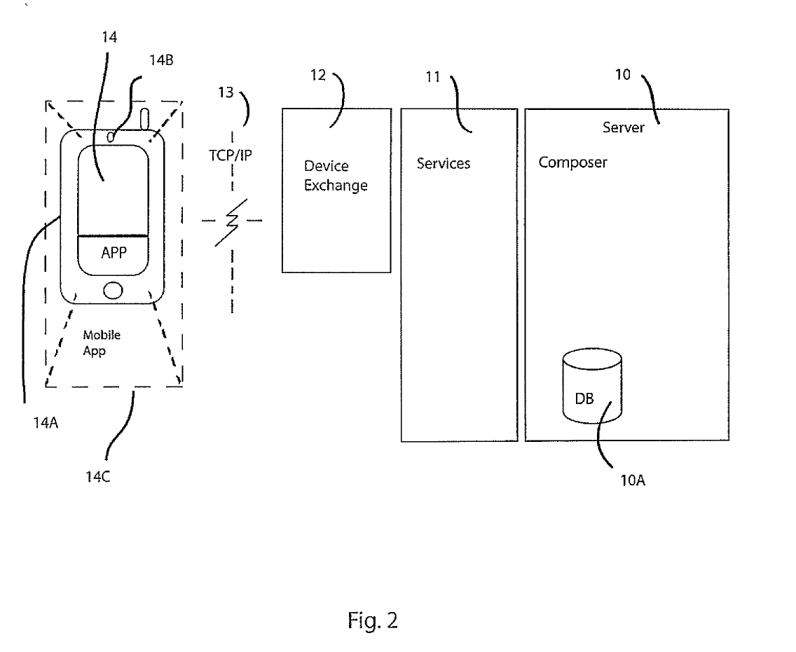

The method and system for communication to an audience at an event includes, as shown in FIG. 2, a central controller 10 having a data base 10A provided by a suitable server which can communication using any one of the available communication systems 13 to a plurality of hand held communication devices 14A.

Typically the system can be run on a PC but other computing systems can be used including cloud computing as a form of operation which includes an offsite component. It will be appreciated that the present system is not limited to the use of a central onsite server.

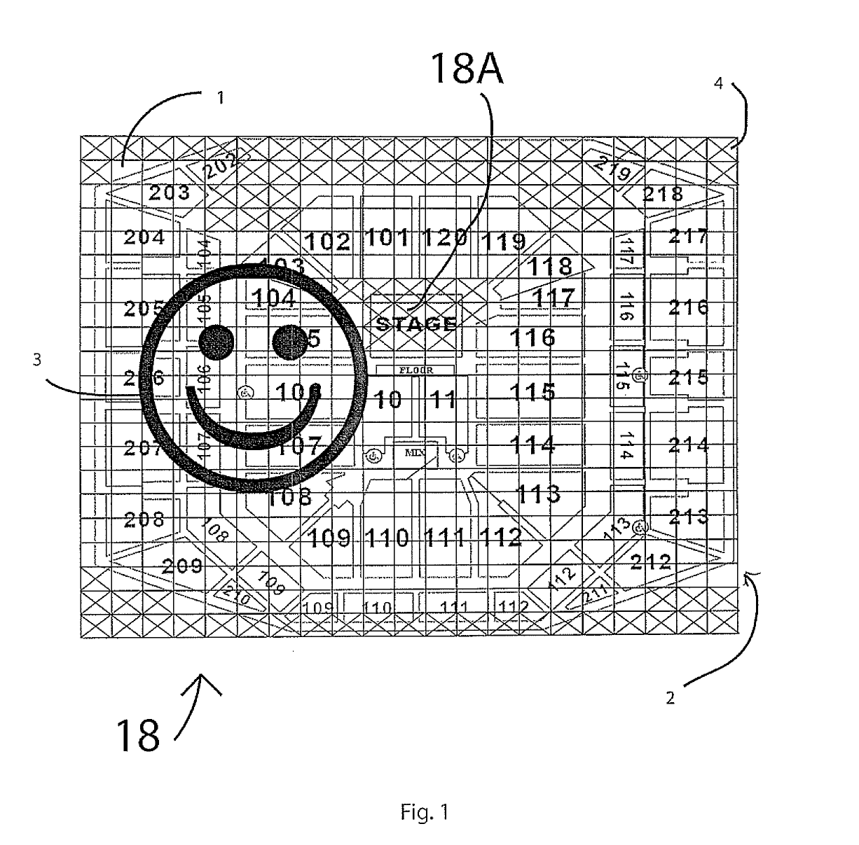

At a live event such as a concert, sporting event or other occasion where audience members are located within an auditorium 18 (FIG. 1) viewing a stage 18A or other location in the auditorium 18. The auditorium can be any location such as a concert hall, theatre, stadium where the audience members can communally see the stage 18A, field, or other points of interest in the event and can see other members in the auditorium.

Some or all of the audience members carry hand held communication devices 14A of any of the types previously described each including a visual display 14 which can be held up by the member to be visible by others of the audience at the event. Each of these devices communicates through the system network 13 using but not limited to one or more Wi-Fi transmitters, and/or cellular, data transfer, and SMS transmission technology.

The system is operated to provide, in advance of, or at the event, a downloadable application or “app” for the mobile device of each of the audience members wishing to participate. Thus conventional mobile devices are programmed by the app to run the system herein. Alternatively dedicated mobile devices can be used which are intended solely for use in the present system and are not intended to function as mobile communication devices at other times and locations.

The system is operated, using the app to collect information from a plurality of the audience members at the event information relating to their presence at the event including preferably their seat location in the event where assigned and identifiable seat locations are available. Where there is no suitable location system available from seat assignments or the like, other forms of geographic triangulation or other location systems can be available to identify the relative positioning of the audience members within the auditorium. That is, some shows have rush seating requiring the use other methods in these cases. Other better technology may also become available that can pinpoint the device 14A sufficiently accurately to carry out the following method.

During the event, the system is operated to communicate data to the hand held communication devices of the audience members. This data may include audio features, display material for the screen and other interactive information. However in the key effect of the present system, the system is operated to coordinate display of a color block or image to the screen 14 of each participating members.

The data to the hand held communication device is coordinated, using the location information in the auditorium so that when the display screens of the hand held communication devices are displayed in the event by the members the display screens cooperate to provide a combined visual effect to the audience, so that in effect each display 14 acts as a known, located single pixel in a macro display. This can be used by the control system in many different ways to display single colors or images periodically or multiple colors or images sequentially.

In FIG. 1, is an illustration of the venue or auditorium and a data assembly method of the graphical design interface. Thus there is shown a venue in which the method of the present invention is to be applied. The method provides a system graphical design Composer which is used by the designer to create the effects and graphics to be displayed.

A sample venue geo-coded map 1 is shown for a specific venue 18. A custom grid overlay 2 is created and a simple graphic 3 to be used in the design is imported and dragged onto the workspace so as to apply the design to the particular venue. The user will make adjustments such as to the size and rotation of a graphic, scale the size of grids, and add movements, time durations as well as many other manipulation types to create a presentation or to apply a previously created presentation to the particular venue to be used.

Each block on the grid overlay 2 represents one pixel, that is the location of one mobile device or more typically a group of mobile devices as determined by their location in the venue. The finer the grid, that is more rows and columns, the larger the number of unique data packets are created which are to be transported to the mobile devices. It will be appreciated that the finer grid selected improves the resolution capabilities of the macro display.

For simple low resolution graphics, the grid does not need to be fine thereby conserving data storage, and processing time. Thus typically a venue holding 20,000 audience members may have a participation level of 20 to 40%. Thus the total number of participants is potentially in the range 4000 to 8000. It is expected that in such a circumstance the venue could be divided into 1200 pixels each containing 5 participants. Alternatively, 20,000 pixels could be used in this case if you have 100% participation or 20,000 users.

A venue geo-coded map 1 is provided for every venue to be used in this system for the purpose of locating all seats in reference to the entire venue. This will allow the system to allocate each user location to the appropriate block on the system grid used.

To further minimize data transmission requirements, areas of the venues where no devices exist or can participate are ignored so as to form grid block-outs 4.

In FIG. 2, which is a schematic representation of an exemplary device data exchange methodology between the base system and the mobile devices, there is provided the composer or central control unit 10, a services device 11, a device exchange 12 which communicates through the mobile network 13 to the mobile devices 14A. The mobile devices each contain a sub-program commonly known as an app which is downloaded via the internet from an app store or other central repository, or the server database 10A on request either at a cost or as a free product to encourage use of the system.

The device exchange 12 implements an architecture that defines a transactional model, an extensible class function set supporting the composition of graphics and messaging, and an integrated set of push notification services. The integrated server layer 10 complements these three aspects of the architecture.

The device exchange 12 operates to insulate the system from cyclical technology changes and updates to OEM mobile devices and their operating systems. Without this, these changes could cause disruption to the entire architecture requiring a rewrite of source code. The device exchange enables the composer, that is server 10, and mobile platforms 14A to function without any knowledge of the other.

Thus the control system 10 acts to generate a proposed display to be communicated to the audience as a macro display obtained using individual pixels created by one of or groups of the mobile devices 14A. As explained above, the mobile devices are typically allocated by their location in the auditorium to a selected one of the pixels of the display. This display is obtained by causing the mobile device of a particular pixel to display on its screen a single color which is sustained for a required period and then cancelled or changed to a different color when required. The pixels are arranged to cancel or go dark when required and to change to a different color when required to generate a macro image on the sum of the pixels which will cause to the persons at the event the appearance of a moving image. The macro optical effect of a moving image or animated effect is necessary for the human brain to fuse together the combination of the pixels to perceive what is being displayed. Without motion of the macro image obtained by changing the colors in a pattern, a person at the venue will have significant difficulty in perceiving the effect or the pattern being displayed.

Having determined the color of the screen to be displayed on the selected mobile device or devices of each pixel, it is necessary then to communicate to each mobile device of the respective pixel the request to make the required display.

Requests are sent to device exchange 12 from the server 10 which are then communicated through the network 13 to the mobile devices 14A. The device exchange 12 accepts the requests, processes them, and returns a response to the server to confirm.

The device exchange 12 is positioned between the mobile platforms 14A and the system server 10. The services server 11 provides a set of methods that can be called upon to send and receive information to the mobile platforms through the device exchange.

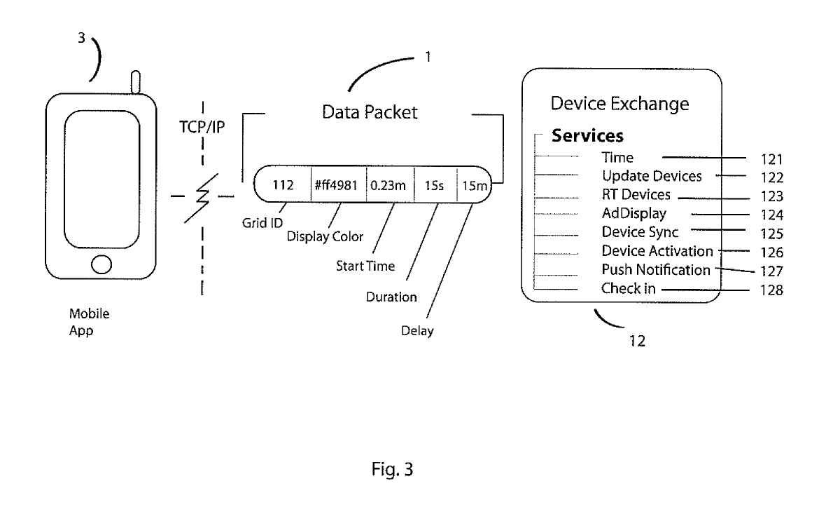

In FIG. 3 a screen command string 1 the controller 10 generates for each display 14 the required instruction to cause display of the required color at the required time based on the grid placement as referenced earlier. This command string or data string includes:

a) a grid block location, that is an ID for the specific mobile concerned. That is the system sends the same global string to all mobiles and the individual mobiles are pre-programed by the system to identify by the ID signal to select those commands directed to them;

b) an RGB value representing the screen color to display;

c) a start time for the color to be displayed;

d) a duration of color display;

e) a time delay to next graphic effect.

These command strings are collated into a single packet of data to be communicated over the network using conventional communication protocols so that a mobile device 14A can receive a single data packet with hundreds of the content strings to be stored using the app for the graphical event to be communicated.

Examples of a set of command strings is as follows:

[Device Content;
{112, #ff4981, 0.23m, 15s, 15m}
{112,3fff0a6, 1.43m, 6s, 12m}
{112, #ffffff, 16.23m, 10s, 5m}
{112, #ff4981,40.15m, 4s, 40m}
{112, #000000, 55.06, 15s, 15m}
{112 #Def657, 65.20m, 2s, 5m}
{112, #ff4981, 7.22m, 4s, 10m}]

The device data exchange system 12 shown in FIG. 3 has a communication module specific to each OEM mobile device operating system platform, so that it is able to integrate with many different mobile device operating systems. That is the Device exchange 12 is arranged to communicate the commands to all mobile devices regardless of their operating environment.

The services contained in the device data exchange system 12 include a series of services as follows:

The Time service 121 which sets the time used by the mobile devices 14A to the synchronized server time to establish a universal clock time for all mobile devices in use at the event and the control system.

The Update Devices service 122 updates the graphic event info on each registered mobile device 14A.

The RTDevices service 123 sends real time information to mobile devices 14A during the event.

The AdDisplay service 124 sends advertisement data to display to registered mobile devices 14A of the specific event.

The DeviceSync service 125 synchronizes devices by checking the time of the mobile device 14A time against the server application time. The purpose of this is to re-confirm that clock times are synchronized.

The DeviceActivation service 126 records user and mobile device 14A data to the server database so that a userid and relevant data can be recorded for the purpose of creating a user account for each user and centralized membership database.

The PushNotification service 127 sends a push notification to all mobile devices 14A registered with the event to alert the user of new data available to download from the server. This will allow any real time or more current data to be transferred to the user device upon their acceptance of the request.

The EventCheckIn service informs the control system that the event attendee and their mobile device 14A have arrived at the venue.

The DBConnect service establishes a server side connection to the database and record set for the venue in order to synchronize the user with the corresponding data of the venue and event they are attending.

The above provides a communication protocol which allows the control system 10 and the mobile devices to establish a communication for use during the event so that the command strings of the Table above can be communicated to the mobile devices during the event and acted upon at the required time. This protocol can be operated using allowed band width while the necessary commands are received and in hand at the mobile device in good time for the required command to be executed at the synchronized time.

These architectural differences are material to the provision of a more efficient presentation and data exchange system. Also, the Device Exchange 12 is material as it acts as a translator containing modules for every OEM operating system platform that the system will communicate with. This allows for easier scalability and accommodation of changes to device operating systems over time.

Thus in operation the plurality of mobile device screens project a synchronized two dimensional motion by individual screen color control to achieve the macro optical effect of moving images or animated effects. The purpose of this is to allow for the human brain to fuse together the combination of mobile displays and macro display motion to perceive what is being displayed.

The screen control command strings transmitted by data packet to the mobile devices require minimal memory storage, server time, and network bandwidth.

While the system is primarily concerned with the visual effect of the arrangement and control of the selected pixels to provide the above moving macro image, the system can also be used for audio effects in which case audio control command strings transmitted by data packet to the devices also can be used while again requiring minimal memory storage, server time, and network bandwidth.

A device sound or vibration can be used to notify the user of a pending graphical display event or a countdown to a display event.

The commands can be used by the downloaded app to calculate based on the synchronized time a display to the user of a screen countdown for users to hold up devices at the correct time.

When the user location is entered by seat location, the mobile device camera 14B can be used for reading a bar code to identify the user seat location where for example a bar code is read off the attendee's ticket thereby eliminating the need to enter the seat location.

As an alternative a data interchange process can be used in communication with the data base of the ticket seller to automate the input of the user's location either to the mobile device, and/or to the command control 11 using an alternative communication route.

In order to carry out the system within an allowable bandwidth, the computer control system can use Cell Broadcast (CB) messaging to transmit a plurality of common screen control command strings which include individual ID addresses for selection by the hand held communication devices. The system can use Cell Broadcast (CB) messaging as a mobile technology feature defined by the ETSI's GSM committee, and part of the GSM standard to transport a single data transmission to many cellular devices simultaneously. Thus the common message includes the instructions for all of the individual mobile devices as a single broadcast. This is a proposed alternative solution based on all mobile devices with cellular capability having a single radio channel open to receive a real time and simultaneous single data stream similar to television broadcast. This minimizes bandwidth requirements.

In this method, screen commands can be transmitted at a fast enough pace to successfully distribute to the plurality of mobile devices at 15-30 data packets per second. In the case of 100,000 mobile devices, 100,000 screen commands could be included per packet. Each mobile device will process only one corresponding screen command per data packet. They do this by selecting the single command segment addressed to that specific device. The result of this method allows for the human eye to establish a smooth continuity of the image sequences. This may be used to produce better synchronization results over the plurality of mobile devices.

As set out before, the same broadcast messages can be used for each mobile device to pick out the relevant data from a cellular broadcast message as it relates to its individual location in reference to the venue and using that data to control the sound output.

Peripheral devices 14C can be provided to enhance the display effect created by the mobile device or phone. For example, the phone could fit into a plastic display magnifier 14C, which enhances or magnifies the display on the screen 14 of the user mobile device. These devices or magnifiers 14C could be handed out at the event or sold.

While the present arrangement is primarily directed to communication with smart phones or other phones or mobile devices held by or used by the attendee on an ongoing basis, it is also possible that the mobile display devices are specifically allocated to audience members at events that will be used specifically for this purpose with the intention that they are disposable or returned after use rather than remain with the user for communication purposes. Such devices can be dedicated to the purpose and hence will have a consistent hardware for improved functionality.

1. Apparatus for communication to an audience at an event comprising:
an arrangement for collecting information from a plurality of audience members at the event relating to their presence and their respective location at the event;
an arrangement for communication through one or more networks with hand held communication devices of the plurality of audience members, each hand held communication device having a display screen which can display a color on the screen;
a computer control system for generating a moving macro image to be displayed to the audience at the event, the moving macro image being made up of individual color pixels where each pixel is defined by one of or a plurality of the hand held communication devices at the respective locations;
the computer control system being arranged to communicate data to the hand held communication devices of the audience members;
the computer control system being arranged such that the data provides instructions to the hand held communication devices so that when the display screens of the hand held communication devices are displayed in the event by the audience members the display screens cooperate to provide a combined visual effect to the audience defined by the moving macro image.

2. The apparatus according to claim 1 wherein the arrangement for collecting information from a plurality of audience members at the event relating to their respective location is arranged such that the information is obtained at the time of the audience member entering the location.

3. The apparatus according to claim 1 wherein the arrangement for collecting information from a plurality of audience members at the event relating to their respective location is arranged such that the information is obtained by seat identification.

4. The apparatus according to claim 3 wherein the information is communicated to the hand held communication devices.

5. The apparatus according to claim 4 wherein the information is communicated by a mobile device camera for reading a bar code to identify user seat location.

6. The apparatus according to claim 3 wherein the information is communicated to the computer control system independently of the hand held communication devices.

7. The apparatus according to claim 6 wherein the information is communicated by a data interchange process in connection with the ticket seller to automate the input of the user's location to the mobile device, and/or the command control database.

8. The apparatus according to claim 1 wherein the arrangement for collecting information from a plurality of audience members at the event relating to their respective location is arranged such that the information is obtained by identifying the coordinates of the hand held communication device.

9. The apparatus according to claim 1 wherein the data is arranged to cause the display screen to display a single solid color patch covering the whole screen.

10. The apparatus according to claim 1 wherein the system includes a downloadable app to be downloaded to each of the hand held communication devices of the audience members when requested.

11. The apparatus according to claim 1 wherein the data communicated to the hand held communication devices also provides audio coordination of the devices.

12. The apparatus according to claim 1 wherein the computer control system is arranged to transmit a plurality of common screen control command strings which include individual ID addresses for selection by the hand held communication devices.

13. The apparatus according to claim 12 wherein the computer control system is arranged to transmit the common screen control command strings using a Cell Broadcast (CB) messaging.

14. The apparatus according to claim 1 wherein the computer control system is arranged to transmit to the hand held communication devices for the image to be displayed at the venue data which provides for a selected hand held communication device a color instruction for display as a solid color patch on the screen and timing information as to when the color patch should be displayed.

15. The apparatus according to claim 1 wherein the computer control system is arranged to transmit an instruction to generate a sound or vibration on the hand held communication device to notify the user of a pending graphical display event or a countdown to a display event.

16. The apparatus according to claim 1 wherein the computer control system is arranged to transmit an instruction to generate a screen countdown for users to hold up devices at the correct time.

17. The apparatus according to claim 1 including a peripheral device for use with the mobile device to enhance the display effect created by the display of the hand held communication device.

18. The apparatus according to claim 17 wherein the peripheral device comprises a display magnifier, which enhances what is displaying on the user mobile device.

19. The apparatus according to claim 1 wherein the computer control system uses Cell Broadcast (CB) messaging to transmit a plurality of common screen control command strings which include individual ID addresses for selection by the hand held communication devices.

20. Apparatus for communication to an audience at an event comprising:
an arrangement for collecting information from a plurality of audience members at the event relating to their presence and their respective location at the event;
an arrangement for communication through one or more networks with hand held communication devices of the plurality of audience members, each hand held communication device having a display screen which can display a color on the screen;
a computer control system for generating an image to be displayed to the audience at the event, the image being made up of individual color pixels where each pixel is defined by one of or a plurality of the hand held communication devices at the respective locations;
the computer control system being arranged to communicate data to the hand held communication devices of the audience members;
the computer control system being arranged such that the data provides instructions to the hand held communication devices so that when the display screens of the hand held communication devices are displayed in the event by the audience members the display screens cooperate to provide a combined visual effect to the audience defined by the image;
wherein the computer control system is arranged to transmit the data by a plurality of common screen control command strings which include individual ID addresses for selection by the hand held communication devices.

21. Apparatus for communication to an audience at an event comprising:
an arrangement for collecting information from a plurality of audience members at the event relating to their presence and their respective location at the event;
an arrangement for communication through one or more networks with hand held communication devices of the plurality of audience members, each hand held communication device having a display screen which can display a color on the screen;
a computer control system for generating an image to be displayed to the audience at the event, the image being made up of individual color pixels where each pixel is defined by one of or a plurality of the hand held communication devices at the respective locations;
the computer control system being arranged to communicate data to the hand held communication devices of the audience members;
the computer control system being arranged such that the data provides instructions to the hand held communication devices so that when the display screens of the hand held communication devices are displayed in the event by the audience members the display screens cooperate to provide a combined visual effect to the audience defined by the image;
wherein the computer control system is arranged to transmit to the hand held communication devices for the image to be displayed at the venue data which provides for a selected hand held communication device a color instruction for display as a solid color patch on the screen and timing information as to when the color patch should be displayed.
